(19) United States
(12) Patent Application Publication
(10) Pub. No.: US 2004/0198095 A1
(43) Pub. Date: Oct. 7, 2004

(54) Compression BNC connector

(76) Inventor: Eric W. Laverick, Whitby (CA)

Correspondence Address: BLANK ROME LLP, THE WATERGATE, 600 NEW HAMPSHIRE AVE N.W., WASHINGTON, DC, 20037, US

(21) Appl. No.: 10/726,138

(22) Filed: Dec. 3, 2003

Related U.S. Application Data
(60) Provisional application No. 60/430,343, filed on Dec. 3, 2002.

(51) Int. Cl. H01R 9/05

(52) U.S. Cl. 439/585

(57) ABSTRACT

The connector of the present invention is terminated to an end of a cable, and comprises the following components, which are arranged coaxially: support mandrel, a swaging barrel surrounding the support mandrel, and a swaging cap outside the swaging barrel. The swaging cap has a variable internal diameter which decreases toward the end facing the cable to form a hump-like inner protrusion, and when moved axially, swages the swaging barrel to secure the outer jacket of the electrical cable.

This Application claims priority to provisional application No. 60/430,343 filed on Dec. 3, 2003.

### FIELD OF INVENTION

The present invention is directed to a connector of the type conventionally known as a BNC connector. Such connectors are known for use in several areas, including, the connection of video and radio-frequency (RF) cables. More particularly, the present invention is directed to a single-piece, RFI-tight, compression BNC connector which has optimized RF performance. The connector according to the present invention can be used in cable television head-end applications and elsewhere in the broadcast industry, e.g., control room and studio environments. Of course, its utility is not limited to the broadcast industry.

### BACKGROUND OF THE INVENTION

BNC connectors are used in a wide range of instruments and for a variety of purposes, ranging from connecting probes on equipment to general input and output of signals. Their popularity stems from their easy availability and relatively low cost. The basic BNC connector is a male type connector mounted at an end of an RF cable. The connector has a center pin connected to the center cable conductor and a metal tube connected to the outer cable shield. A rotating ring outside the tube locks the cable to a corresponding female connector.

One method of terminating the connector is to insert an electrical cable into a rear barrel, and using a tool, crimp the barrel around the electrical cable's jacket to secure it thereto. However, that method requires the use of a tool (please confirm) that encircles the barrel and crimps it down onto the cable jacket. That process is unwieldy and inconvenient, and often yields an inconsistent crimping force resulting in a crimp that is too loose or too tight.

Therefore, it would be advantageous to provide a BNC connector that simplifies the termination of the BNC connector, and yields a consistent crimping force. Furthermore, because BNC connectors are produced in large numbers, relatively minor manufacturing cost savings can have a significant impact on the profitability of the connectors. Therefore, it would be advantageous to provide a BNC connector which is terminated more quickly and efficiently, to reduce the manufacturing cost of assembling the connector to an electrical cable.

### SUMMARY AND OBJECTS OF THE INVENTION

The present invention is directed to a connector, preferably a BNC type, for terminating the end of a cable. A rear end of the connector, which is connected to the cable, comprises the following components, which are arranged coaxially: support mandrel, a swaging barrel surrounding the support mandrel, and a swaging cap outside the swaging barrel. The support mandrel has holding spurs or barbs. The swaging barrel is made of a material which can be swaged under sufficient pressure. The swaging cap has a variable internal diameter which decreases toward the end facing the cable to form a hump-like inner protrusion.

The cable is inserted such that the outer conductor is disposed between the support mandrel and the swaging barrel. Then, the swaging cap is pushed with an appropriate tool so that its inner protrusion swages the swaging barrel against the cable outer conductor. Thus, the cable outer conductor is compressed against the holding barbs of the support mandrel.

The connector of the present invention further comprises a center contact which forms the pin of the BNC connector. The center contact is hollow so as to receive the inner conductor of the cable. The center contact has inwardly extending tangs which contact the inner conductor.

The connector still further comprises an outer connecting barrel which provides an RFI-tight connection with improved stress resistance. The slots are lengthened, and a dimple functioning as a secondary stress relief area is provided.

Modifications of the connector are possible. For example, the swaging barrel can be solid or slotted. Other features of the present invention will be understood from the specification sheet and the drawings.

### BRIEF DESCRIPTION OF THE DRAWINGS

FIG. 1 shows a connector of the present invention in an open position;

FIG. 2 shows the connector of the present invention in the open position coupled to an electrical cable;

FIG. 3 shows the connector of the present invention coupled to an electrical cable in a closed position;

FIG. 4 shows an electrical cable;

FIG. 5 shows the electrical cable prior to coupling with the connector of the present invention;

FIG. 6 shows two alternative embodiments of a swaging barrel;

FIG. 7 shows a contact for the front portion of the connector of the present invention;

FIG. 8 shows a sectional view of line 8-8 of FIG. 7;

FIG. 9A shows a finger of a front barrel of the connector;

FIG. 9B shows a prior art front barrel finger;

FIG. 10A shows the finger of the front barrel mated to a corresponding barrel; and

FIG. 10B shows a prior art front barrel finger mated to a corresponding barrel.

### DETAILED DESCRIPTION OF THE PREFERRED EMBODIMENT

Referring now to the several drawing figures in which identical elements are numbered identically throughout, a description of the preferred embodiment of the present invention will be provided.

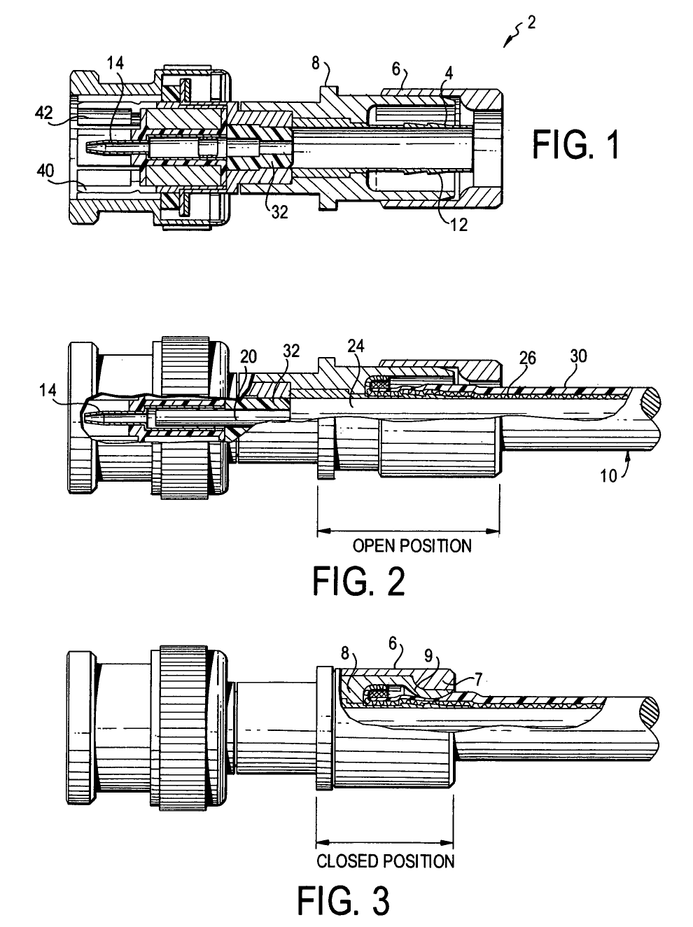

FIG. 1 shows the BNC connector 2 of the present invention in an open position prior to attachment to an electrical cable 10. FIGS. 2 and 3 show the steps for attaching the BNC connector 2 to the electrical cable 10.

Referring to FIG. 1, a rear portion of the BNC connector 2 is terminated onto an electrical cable 10, and includes a support mandrel 4, a swaging cap 6 and a swaging barrel 8. The support mandrel 4 includes a plurality of spurs 12 that engage a cable jacket, as explained below. A front portion of the BNC connector 2 includes a contact 14, into which the conductor of the electrical cable 10 is inserted. The contact 14 is surrounded by a front barrel 40 that mates with the corresponding female receptacle (not shown). The front barrel 40 includes six resilient spring fingers 42 that engage a corresponding barrel in the female receptacle.

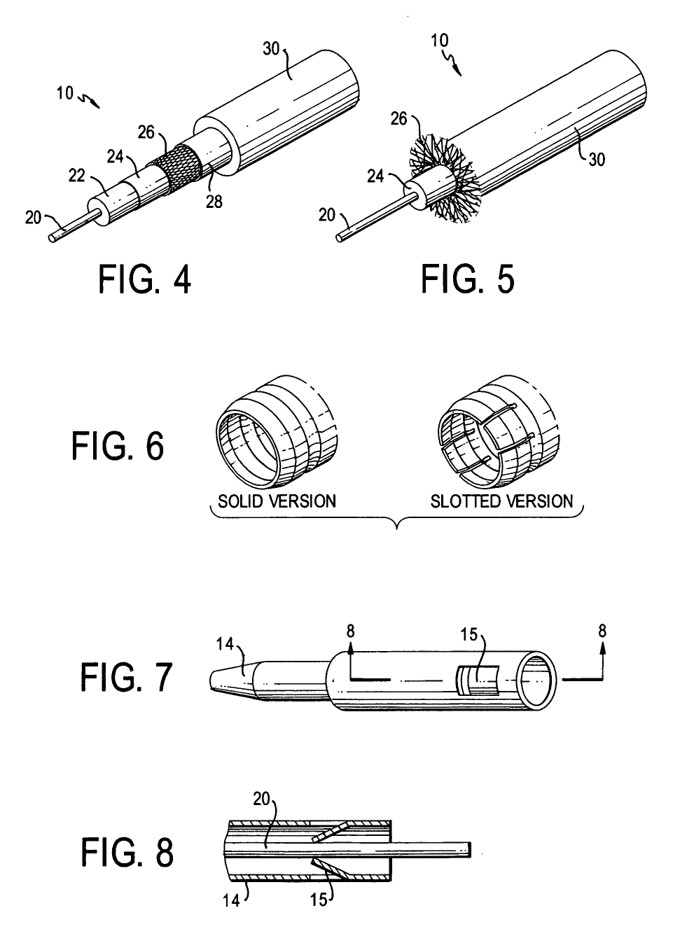

FIGS. 4 and 5 show the electrical cable 10. FIG. 4 shows the various layers of the electrical cable, which include, starting from the center and going outward, its center conductor 20, an inner dielectric 22, a inner foil 24, a weaved shielding braid 26, an outer foil 28, and an outer cable jacket 30. Prior to inserting the electrical cable 10 into the BNC connector 2, the electrical cable 10 is partially stripped, as shown in FIG. 5. The outer foil 28 is removed and the shielding braid 26 is pulled back so that the inner dielectric 22 and the inner foil 24 are partially exposed. Furthermore, the inner dielectric 22 and the inner foil 24 are removed along a portion of the cable so that the center conductor 20 is exposed. It should be understood that the electrical cable 30 described herein is provided for exemplary purposes, and that cables having additional layers, or cables having layers removed, may be used with the present invention without departing from the spirit or scope of the invention.

The electrical cable 10 is inserted into the rear portion of the BNC connector 2, through the support mandrel 4, so that the conductor 20 protrudes into the front barrel 40 of the connector, and into the interior of the contact 14. The inner dielectric 22 and inner foil 24 are inserted into the support mandrel 4 and abut a retainer wall 32 adjacent thereto. However, the edge of the support mandrel 4 slides underneath the shielding braid 26 and outer cable jacket 30, so that they are inserted over and around the support mandrel 4. That is best shown in FIG. 2, which illustrates the shielding braid 26 and cable jacket 30 located between the support mandrel 4 and the swaging barrel 8, and in particular, shows a protracted portion of the shielding braid 26 curling against an interior wall of the swaging barrel 8.

After the electrical cable is inserted, the swaging cap 6 is moved along the length of the swaging barrel 8, by hand or tool, into a closed position, shown in FIG. 3. The swaging cap 6 includes a protrusion 7 on its end, which upon being moved, deforms an arm 9 of the swaging barrel 8 into contact with the cable jacket 30. The cable jacket 30 and shielding braid 26 are then secured between the deformed arm 9 and the spurs 12 on the support mandrel 4. FIG. 6 shows two alternative embodiments of the swaging barrel 8, one solid and the other slotted. Either type of swaging barrel 8 may be used depending on the application.

FIGS. 7 and 8 show the front contact 14 in greater detail. The contact 14 has a hollowed interior with at least two spring tangs 15 inclined inwardly into the hollowed interior. The tangs 15 resiliently engage the conductor 20 upon insertion of the electrical cable 30, and provide a continuous electrical connection between the conductor 20 and the contact 14.

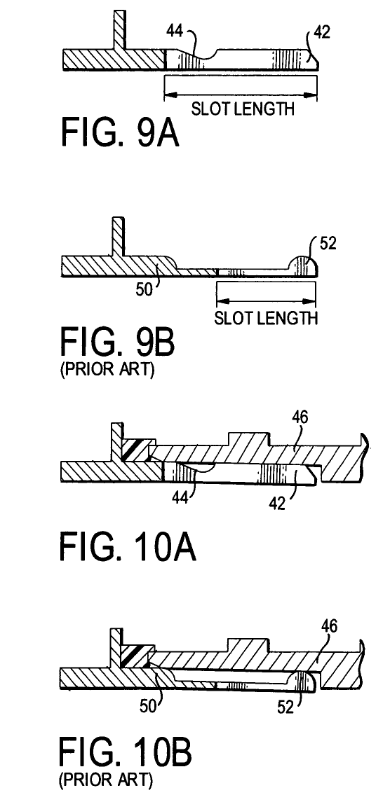

FIGS. 9A and 10A show a further improvement of the present invention directed towards the fingers 42 of the front barrel 40. It should be noted that in FIG. 1, the fingers 42 extend to the left, so that a corresponding female receptacle is inserted from the left to the right. In FIGS. 9A and 10A, the finger 42 extends to the right, and the female receptacle is inserted from the right to the left. Furthermore, the finger 42 shown in FIG. 9A and 10A is formed from a top portion of the barrel 40, so that a hollowed out portion or dimple 44 faces outwardly. Upon mating the front barrel 40 with a barrel 46 of a corresponding female receptacle, the fingers 42 of the front barrel 40 are deflected inwardly to provide a frictional engagement between the two barrels. The dimple 44 provides a stress relief region that reduces the stress in the finger 42 by making it easier for the finger 42 to deflect. Additionally, the slot length of the finger 42 is lengthened so that it is better able to bend. The increased slot length and dimple 44 make it easy for the finger 42 to adjust to the inclined plane of the barrel 46 of the female receptacle so that they contact each other over a larger surface area. The increased contact area provides better shielding for the connector.

That construction is in contrast to the prior art fingers 50 shown in FIGS. 9B and 10B. The prior art fingers 50 do not have a dimple 44 and typically include a protuberance 52 on an end thereof. When mated with a barrel of a corresponding female receptacle, as shown in FIG. 10B, the protuberance 52 abuts the finger 46 of the female receptacle so that only its tip contacts the finger 46. Furthermore, because the finger 50 does not include a dimple, the finger 50 does not have a suitable position that deflects with the finger 46. That creates stress in the finger 50.

It should be appreciated that many other modifications and variations of the present invention are possible in light of the above teachings, without departing from the spirit or scope of the invention. For example, the preferred materials described above may be modified or changed so long as they individually, and in combination, perform their intended function.

I claim:

1. A connector comprising:
a first connecting end; and
a second end for attachment to a cable, the second end comprising:
a support mandrel;
a swaging barrel, surrounding the support mandrel to be coaxial with the support mandrel; and
a swaging cap, surrounding the swaging barrel to be coaxial with the swaging barrel and the support mandrel, the swaging cap having a variable inner diameter for swaging the swaging barrel onto an outer jacket of the cable.

2. The connector of claim 1, wherein the swaging cap is adapted to move axially over the swaging barrel to swag the swaging barrel onto the outer jacket of the cable.

3. The connector of claim 1, wherein the first connecting end comprises a center contact for attachment to an inner conductor of the cable, the center contact having a hollow space for receiving the inner conductor and tangs extending into the hollow space for contacting the inner conductor.

4. The connector of claim 1, wherein the first connecting end includes a slotted barrel adapted to receive a corresponding barrel, and having a finger with a recess for strain relief.

5. The connector of claim 1, wherein the connector is a BNC-type connector

6. A cable termination comprising:
a connector having a first connecting end for attachment to a corresponding connector, a second connecting end for terminating an electrical cable, the second connecting end having a support mandrel, a swaging barrel coaxially surrounding the support mandrel, and a swaging cap coaxially surrounding the swaging barrel;
wherein the electrical cable comprises at least a conductor and an outer jacket, and the conductor is located inside the support mandrel and the outer jacket is located outside the support mandrel; and
the swaging cap having a variable inner diameter for swaging the swaging barrel onto an outer jacket of the electrical conductor.

7. The cable termination of claim 6 wherein:
the outer jacket is located between the support mandrel and the swaging barrel.

8. The cable termination of claim 6 wherein:
the support mandrel includes spurs for engaging the outer jacket.

9. The cable termination of claim 6 wherein:
the first connecting end includes a contact having tangs that extend into its interior, and the conductor of the electrical cable extending into the contact and engaging the tangs.

10. The cable termination of claim 6 wherein:
wherein the first connecting end includes a slotted barrel adapted to receive a corresponding barrel, and having a finger with a recess for strain relief.

11. The cable termination of claim 6 wherein:
the connector is a BNC-type connector.

12. A method of terminating a cable comprising:
providing a connector comprising a first connecting end and a second end for attachment to a cable, the second end comprising a support mandrel, a swaging barrel coaxially surrounding the support mandrel, and a swaging cap coaxially surrounding the swaging barrel, the swaging cap having a variable inner diameter for swaging the swaging barrel onto an outer jacket of the cable;
inserting a cable into the second end of the connector so that the outer jacket is located between the support mandrel and swaging barrel; and
sliding the swaging cap along the swaging barrel to deform the swaging barrel into contact with the outer jacket of the cable.

13. The method of terminating a cable of claim 12, wherein the first connecting end comprises a center contact having tangs extending into its interior, and the cable includes a conductor; and
whereupon insertion of the cable, the conductor engages the tangs of the contact.

14. The method of terminating a cable of claim 12, wherein the first connecting end includes a slotted barrel adapted to receive a corresponding barrel, and having a finger with a recess for strain relief.
